(19) United States
(12) Patent Application Publication
(10) Pub. No.: US 2010/0095495 A1
(43) Pub. Date: Apr. 22, 2010

(54) ANTI-THEFT INK TAG

(76) Inventors: Thang Tat Nguyen, Boca Raton, FL (US); Dale W. Raymond, Boca Raton, FL (US)

Correspondence Address: Tyco International LTD, Ip Legal Department, One Town Center Road, BOCA RATON, FL, 33486, US

(21) Appl. No.: 12/449,557

(22) PCT Filed: Feb. 20, 2008
(86) PCT No.: PCT/US08/02266

§ 371 Date: Aug. 12, 2009

Related U.S. Application Data
(60) Provisional application No. 60/902,412, filed on Feb. 20, 2007.

(51) Int. Cl. E05B 73/00

(52) U.S. Cl. 24/704.1

(57) ABSTRACT

A theft-deterrent device (10) for application to an article to be protected includes first (20) and second (30) components adapted for locking engagement to secure the article therebetween, with a fragile vile (60) disposed within the first component containing a detrimental substance which would damage the article in the event the vial is fractured. A pin (15) protruding from the first component has a first end secured to the vial using a suitable attachment structure. The attachment structure provides an aperture which surrounds a portion of the “vial in a closely engaged arrangement, and also serves to rupture the vial and release the detrimental substance if unauthorized removal is attempted. The pin and the attachment structure can be integrally formed, or alternatively the attachment structure can be formed as a separate piece and attached to the pin.

### FIELD OF THE INVENTION

This invention relates generally to theft deterrent devices providing benefit denial, and more particularly to an improved anti theft ink tag used to deter the theft of articles by permanently staining the article if unauthorized removal of the tag is attempted.

### BACKGROUND

The prior art includes numerous conventional theft deterrent devices of the “benefit denial” type which use ink to stain the fabric of a garment when unauthorized attempts have been made to remove the tag from the garment. Usually the ink is contained in one or more frangible containers, such as tubes or vials comprised of glass or rigid plastic which are carried in the housing of the tag. The housing is secured to the garment to be protected by an attachment structure of a type which is releasable upon use of specialized release devices by authorized personnel. Such attachment generally takes the form of a tack carried on one section of the tag which is pushed through a layer of the fabric of the garment into a receptacle carried on another section of the tag. The substance contained within the vials is released when a fracturing element is flexed so that the vial is broken, releasing the substance.

Known devices are typically assembled with two sealed cylindrical glass vials containing a liquid stain or indelible ink fluid, each vial lying alongside the vertical axis of the tack and requiring a breaker plate that is attached to the grooved tack (nail) and lying along the top or surrounding the vials in such a manner as to break the ink vial with pressure when the grooved tack or nail transmits a compressive force exceeding the vial strength.

In known ink-tack type deterrent devices, symmetrical placement of the tack with relation to the ink tags usually requires the use of at least two ink vials. When two or more ink vials are used in the tack assembly, a wider range of the compression force is required to fracture each vial, and the product size is larger and more costly to manufacture.

It would be therefore be highly advantageous to provide an improved ink tag design which is configured to use a single vial which is symmetric about the tack. The ink tag as disclosed herein which utilizes a single vial requires less compression force to rupture the vial than prior art ink tags, and also provides better control of the required pressure. Product size is also advantageously reduced, thereby reducing manufacturing costs.

### SUMMARY OF THE INVENTION

An anti-theft ink tag device for application to an article to be protected includes first and second components adapted for locking engagement to secure the article therebetween, with a fragile vile disposed within the first component containing a detrimental substance which would damage the article in the event the vial is fractured. A pin protruding from the first component has a first end secured to the vial using a suitable attachment structure. The attachment structure provides an aperture which surrounds a portion of the vial in a closely engaged arrangement, and also serves to rupture the vial and release the detrimental substance if unauthorized removal is attempted. The pin and the attachment structure can be integrally formed, or alternatively the attachment structure can be formed as a separate piece and attached to the pin.

A theft deterrent ink tag in accordance with one embodiment of the invention includes a one piece eyelet pin. The eyelet pin includes an integral a ring which surrounds the ink vial and serves to rupture the vial if removal is attempted. The eyelet ring can be formed symmetrical with respect to the pin, or off set from the central axis of the pin. The eyelet ring can be a closed ring or an open ring. In another embodiment, a pin is attached to a pin-retaining sleeve having a cylindrical aperture for receiving the vial in longitudinal orientation.

### BRIEF DESCRIPTION OF THE DRAWINGS

FIG. 1A is a cross-sectional view of the first and second components of a theft-deterrent device according to the invention in a detached configuration depicting the fragile vial disposed within the first component;

FIG. 1B is a perspective view of an embodiment of the first component;

FIG. 1C is a cross-sectional side end view of the first component of FIG. 1A;

FIG. 2 illustrates the fragile vile with a pin having an integral attachment structure according to one embodiment of the invention;

FIG. 3 is pin having an integral attachment structure according to another embodiment;

FIG. 4 illustrates the pressure exerted on the vial when unauthorized removal is attempted;

FIG. 5 illustrates another embodiment of the pin in which the attachment structure is offset from the axis of the pin;

FIG. 6 is another embodiment in which the attachment structure is formed as a pin-retaining sleeve;

FIG. 7 is an alternative configuration of the embodiment of FIG. 4;

FIG. 8 illustrates yet another embodiment in which the attachment structure is formed as a flexible loop; and

FIG. 9 illustrates yet another embodiment in which the attachment structure is formed as a generally annular portion which is formed as a separate piece and then attached to the pin.

### DETAILED DESCRIPTION

For simplicity and ease of explanation, the invention will be described herein in connection with various embodiments thereof. Those skilled in the art will recognize, however, that the features and advantages of the invention may be implemented in a variety of configurations. It is to be understood, therefore, that the embodiments described herein are presented by way of illustration, not of limitation.

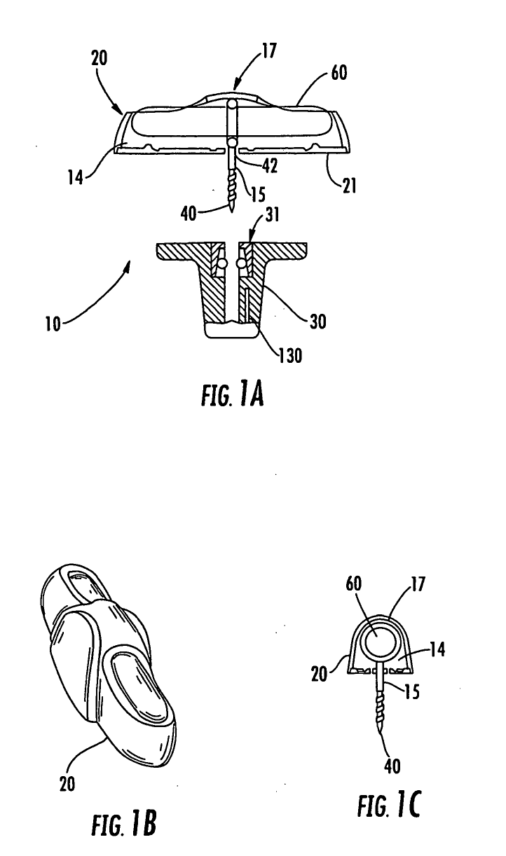

FIGS. 1A-C illustrates an ink tack type theft deterrent device 10 according to a one embodiment of the invention. The device 10 includes a first component 20 and a second component 30 which are adapted for locking complementary engagement to secure a portion of an article to be protected (not shown) therebetween. The first component 20 and second component 30 can be formed from any suitable rigid material, such as plastic. The first and second components 20 and 30 can be locked together using a pin 15 extending from the first component and a cooperating clutch 31 in the second component 30. The pin 15 has an upper first end (generally referred to as 17) disposed within the first component 20 and a second piercing end 40 protruding outwardly from a flat lower wall 21. The clutch 31 in the second component 30 is adapted to grasp the pin 15. In use, the pin 15 pierces a portion of an article to be protected, and the first and second components are locked together by insertion of the pin 15 into the clutch 31. The pin 15, the clutch 31 and the technique of releasing the pin 15 from the grasp of the clutch 31 to allow the first component 20 to be unlocked from the second component 30 to detach the protected article from the theft-deterrent device are described in U.S. Pat. No. 4,523,356 to Lincoln H. Charlot, Jr.

The first component 20 is formed with a cavity 14 therein configured to contain an elongated sealed vial 60. The illustrated vial 60 is cylindrical in configuration, however the invention is not limited in that regard. The vial 60 is made of a fragile material, such as glass or frangible plastic, and it breaks easily under application of a longitudinal bending moment. The vial is filled with a theft deterrent substance, such as ink or other detrimental substances that permanently stain and marks the article when released. In addition to a staining substance, many other types of substances can be used for detrimental effect, such as bleach, or ill-smelling, fume-generating or skin-irritating substances in gas, liquid or powder form. Preferably the vial 60 is made of a transparent or translucent material so that the condition of the detrimental substance can be inspected, and that the public is made aware of the presence of its contents.

Either or both of the first component 20 and the second component 30 can include an EAS tag or label disposed therein to provide enhanced security for the protected article. As shown in FIG. 1, the second component 30 includes EAS tag or label 130.

The first end 17 of the pin 15 is secured within the cavity 14 by securing the pin 15 to the vial 60 trapped within the cavity 14. The first end of the pin 17 is attached to the vial 60 such that the shaft of the pin 15 extends through an opening 42 in the lower wall 21. The opening 42 is sized for close alignment with the shaft of the pin 15 to maintain the pin 15 approximately normal to the lower wall 21, but is large enough in diameter to allow some vertical movement of the pin 15 with respect to the cavity 14. In this and other embodiments disclosed therein, an attachment structure serves to attach the pin 15 to the vial 60, and also advantageously functions to rupture the vial 60 if unauthorized removal is attempted.

As shown in FIG. 4, an attempt to separate the first and second components for authorized removal of the device 10 from the garment results in a downward force on the pin 15, causing the downward motion of the pin 15 with respect to the cavity 14 such that the first end 17 ruptures the vial 60 to release the detrimental substance. The lower wall 21 of the first component 20 can include other openings therein to aid in dispersal of the detrimental substance when the vial 60 is ruptured. The longitudinal center of the vial 60 is usually the area most vulnerable to fracture, and the pin 15 is therefore located at the approximately longitudinal center of the vial 60 in the illustrated embodiments. However, in alternative designs the pin 15 could be asymmetrically positioned along the vial 60.

The cavity 14 can also be contoured to provide pressure points at various locations which serve to hasten the destruction of the vial 60 when the pin 15 is subjected to downward force. As shown in FIG. 4, the cavity can include, for example, protrusions 48 and 49 which are positioned at predetermined pressure points and which cooperate with the attachment structure to rupture the vial 60 if unauthorized removal is attempted.

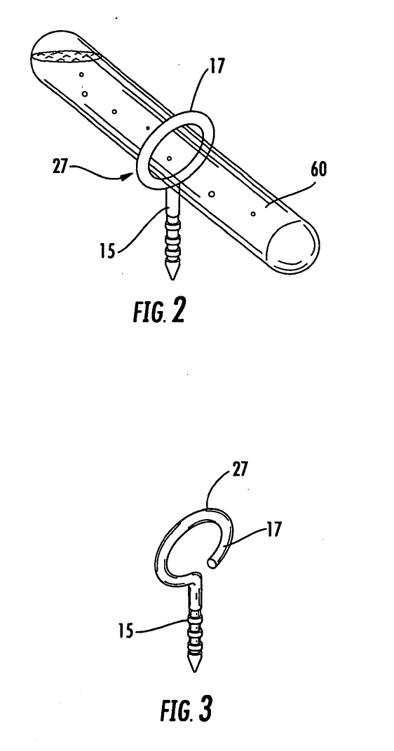

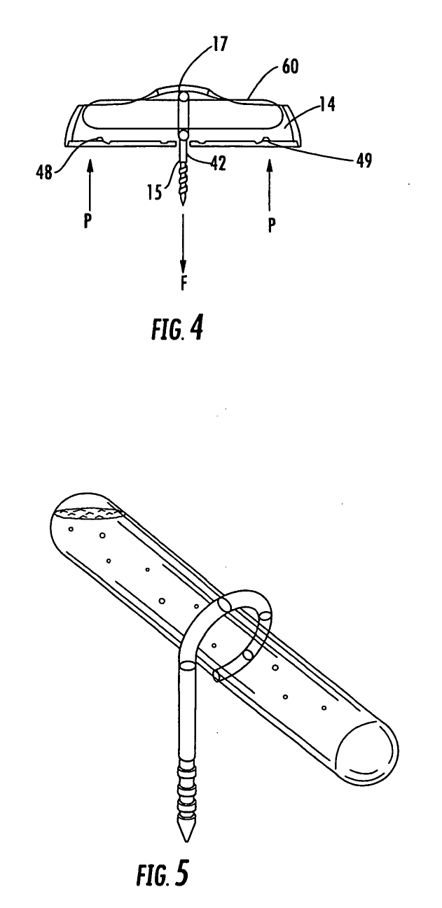

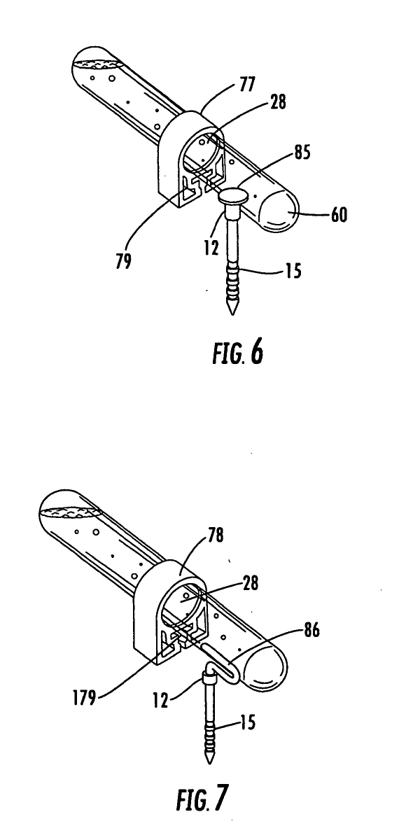

In the embodiments shown in FIGS. 2, 3, and 5 the pin 15 and attachment structure are formed as a unitary piece. In this embodiment, the first end 17 of the pin 15 is formed as an aperture or eyelet 27 which is configured for close sliding engagement with the vial 60. The aperture or eyelet 27 can have any suitable configuration which engages with the vial 60 to secure the pin and also imparts adequate suitable breaking force to the vial. The first end 17 can also be formed in such as the open ring (or hook) configuration shown in FIG. 3. As shown in FIG. 5, the first end 17 of the pin 15 can be configured as an integrally formed aperture or eyelet 27 which is asymmetrically positioned with respect to the axis of the pin 15.

In the embodiment shown in FIG. 6, the means to secure the pin 15 to the vial 60 can be in the form of a sleeve member 77 having a cylindrical opening 78 sized to receive the vial 60 therein in a longitudinal orientation. The sleeve member 77 is attached to the first end 17 of the pin 15 using any suitable attachment means. In the illustrated embodiment shown in FIG. 6, the first end 17 of the pin 15 is formed as flat pin head 85, and the sleeve member 77 includes a slot 79 configured to engage with the pin head 85 to allow sliding insertion at the time of manufacture, but which prevent vertical displacement of the pin 15 with respect to the sleeve member 77 in the assembled device 10. In this embodiment, the slot 70 provides a T-shaped opening complementary to the side profile of the pin 15 and pin head 85, allowing the pin 15 to be inserted therein such that the T-shaped opening supports the pin head 85 of the pin 15. This configuration prevents the forced extraction of the pin 15 from the sleeve using a downward motion since lateral displacement of the pin 15 is prevented when the first component 20 is fully assembled.

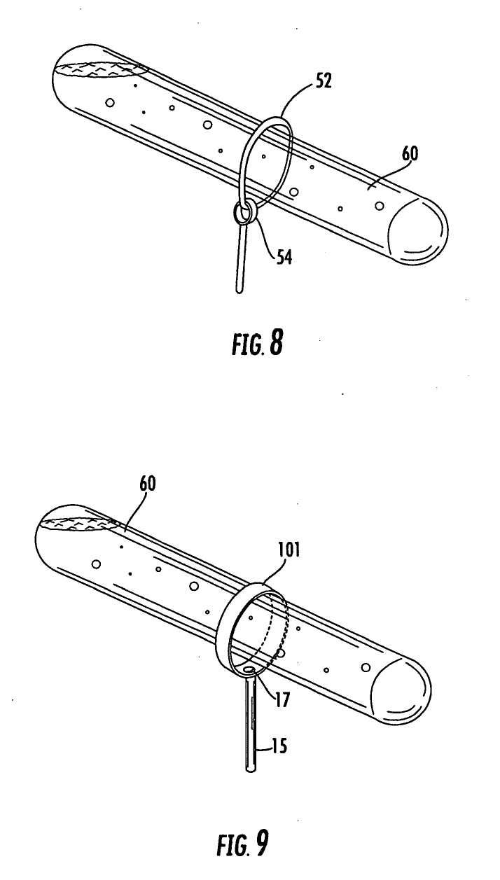

FIG. 7 illustrates another embodiment of the sleeve member 77 adapted for use with a pin having a first end 17 formed as hook 86. In this embodiment, the sleeve member 78 includes a slot 179 which is configured to engage with the hook 86 to secure the pin 15 and prevent extraction using a downward force. The sleeve member 78 can similarly be adapted to include a slot opening having a shape complementary to any desired configuration of the first end 17 of the pin 15 to retain the pin therein. The sleeve member 78 can include an aperture to receive the first end 17 in a press-fit fashion, so that the sleeve member 78 is fixedly secured to the pin 15.

FIG. 8 illustrates yet another embodiment in which the attachment structure is formed as a flexible loop 52 attached to the first end 17 and of pin 15. The flexible loop 52 can be any material having sufficient strength to break the vial 60 when force is applied, such as wire, plastic line, etc. In this embodiment, the pin 15 includes a threading aperture 54 allowing the flexible loop to be secured therethrough.

FIG. 9 illustrates yet another embodiment in which the attachment structure is formed as a generally annular portion (or eyelet ring) 101 which is formed as a separate piece and then attached to the first end 17 of the pin 15. The eyelet ring 101 is configured to engage with the vial and can be formed from any suitable material, such as metal, sheet metal, wire, plastic, composite, fiber, etc. The eyelet ring 101 is attached to the pin 15 using any suitable method such as welding, bonding, snapping, hooking, riveting, swaging, etc.

The eyelet ring can be formed into the closed ring-shape as shown in the FIG. 9, or a ring having an opening therein. In other embodiments, the attachment structure can have a non-annular configuration. The attachment structure can have any suitable shape which serves to encompass and fracture the ink vial when force is applied.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. A theft-deterrent device for application to an article to be protected, said device comprising:
an elongated fragile vial containing a detrimental substance sealed therein which would damage said article in the event said vial is fractured;
first and second components adapted for locking complementary engagement wherein said first component includes a cavity adapted to contain said vial and said vial is disposed in said first component;
a pin having a first end secured to said vial and a second end protruding from said first component, said second component including a clutch for grasping said second end of said pin to provide locking engagement between said first and second components; and
attachment structure for securing said pin to said vial, said attachment structure providing an aperture surrounding a portion of said vial in a closely engaged arrangement whereby said attachment structure serves to rupture the vial when downward force is exerted on said pin.

2. The device of claim 2, wherein said attachment structure and said pin are formed from metal as a unitary piece.

3. The device of claim 2, wherein said attachment structure comprises an eyelet portion formed integrally with said first end of said pin.

4. The device of claim 2, wherein said attachment structure comprises a hook portion formed integrally with said first end of said pin.

5. The device of claim 1, wherein said attachment structure is a sleeve member providing a cylindrical opening for receiving said vial in a longitudinal orientation, and said sleeve member includes a pin-retaining means engagable with said first end of said pin.

6. The device of claim 5, wherein said first end of said pin is formed as a head, and said pin-retaining means comprises a slot to receive a portion of said first end of said pin wherein said slot is configured to engage with said head to prevent vertical displacement of said pin with respect to said sleeve member.

7. The device of claim 5, wherein said first end of said pin is formed as a hook structure, said pin-retaining means comprises a slot to receive a portion of said first end of said pin wherein said slot is configured to engage with said hook structure to prevent vertical displacement of said pin with respect to said sleeve member.

8. The device of claim 1, wherein said attachment structure comprises a flexible loop portion attached to said first end of said pin, wherein said flexible loop portion is configured to laterally encircle said vial.

9. A theft-deterrent device for application to an article to be protected, said device comprising:
an elongated fragile vial containing a detrimental substance sealed therein which would damage said article in the event said vial is fractured;
first and second components adapted for locking complementary engagement wherein said first component includes a cavity adapted to contain said vial and said vial is disposed in said first component; and
a pin having a first end and a second end, said second end of said pin protruding from said first component and said second component including a clutch for grasping said second end of said pin to provide locking engagement between said first and second components, said first end of said pin end being configured as an annular portion sized to receive said vial therein in a longitudinal orientation wherein said vial is inserted through said annular portion to secure said pin to said vial, whereby said annular portion serves to rupture the vial when downward force is exerted on said pin.

10. The device of claim 9, wherein said annular portion comprises an eyelet portion formed integrally with said first end of said pin.

11. The device of claim 9, wherein said annular portion is comprises a hook portion formed integrally with said first end of said pin.

12. The device of claim 8, wherein said cavity includes at least one protrusion therein positioned to cooperate with said annular portion to hasten the destruction of said vial when downward force is exerted on said pin.

13. The device of claim 9, wherein said annular portion is metal.

14. The device of claim 9, wherein said annular portion is plastic.

15. The device of claim 9, wherein said annular portion is a flexible loop.

16. The device of claim 9, wherein said annular portion is a formed from wire.

17. The device of claim 9, wherein said annular portion is a formed from sheet metal.

18. The device of claim 9, wherein said annular portion attached to said pin by welding.

19. The device of claim 9, wherein said pin is press-fit into said annular portion.
